(19) United States
(12) Patent Application Publication
(10) Pub. No.: US 2025/0293311 A1
(43) Pub. Date: Sep. 18, 2025

(54) ALL-SOLID-STATE BATTERY AND MANUFACTURING METHOD THEREOF

(71) Applicant: HONDA MOTOR CO., LTD., Tokyo (JP)

(72) Inventors: Yusuke YOSHIZAKI, Saitama (JP); Takuro SASANO, Saitama (JP); Shuji FUTAGAMI, Saitama (JP); Takashi TOYOSHIMA, Saitama (JP)

(21) Appl. No.: 19/064,743

(22) Filed: Feb. 27, 2025

(30) Foreign Application Priority Data
Mar. 15, 2024 (JP) 2024-040874

(51) Int. Cl. H01M 10/0585; H01M 50/449; H01M 50/46

(52) U.S. Cl. CPC H01M 10/0585; H01M 50/449; H01M 50/461; H01M 2300/0094

(57) ABSTRACT

An all-solid-state battery according to one embodiment of the present invention includes a positive electrode layer, a negative electrode layer, and a solid electrolyte layer arranged between the positive electrode layer and the negative electrode layer. The solid electrolyte layer is a stack that includes a first solid electrolyte layer and a second solid electrolyte layer stacked on one surface of the first solid electrolyte layer. The first solid electrolyte layer includes a porous base material and a first solid electrolyte composition containing a solid electrolyte filled into the pores of the porous base material. The second solid electrolyte layer includes a second solid electrolyte composition containing a solid electrolyte and does not include a base material.

This application is based on and claims the benefit of priority from Japanese Patent Application No. 2024-040874, filed on 15 Mar. 2024, the content of which is incorporated herein by reference.

### BACKGROUND OF THE INVENTION

### Field of the Invention

The present invention relates to an all-solid-state battery and a method of manufacturing the same.

### Related Art

In recent years, research and development have been conducted on secondary batteries that contribute to energy efficiency, in order to enable more people to access affordable, reliable, sustainable, and advanced energy. Among secondary batteries, all-solid-state batteries including a pressure-bonded laminate formed by arranging a solid electrolyte layer between a positive electrode layer and a negative electrode layer and pressure-bonding the layers are especially noteworthy in terms of the enhanced safety resulting from the non-flammable solid electrolyte, and the higher energy density. A known solid electrolyte layer for an all-solid-state battery is formed by filling pores of a porous base material with a solid electrolyte (Patent Document 1 and Patent Document 2).
Patent Document 1: Japanese Unexamined Patent Application, Publication No. 2015-153460
Patent Document 2: Japanese Unexamined Patent Application, Publication No. 2021-163759

### SUMMARY OF THE INVENTION

In all-solid-state battery technology, improving high-rate performance is a recognized challenge. Enhancing the ion conductivity of the solid electrolyte layer is effective for improving high-rate characteristic of all-solid-state batteries. However, solid electrolyte layers formed by filling the pores of a porous base material with a solid electrolyte may develop pinholes between the pores of the porous base material and the solid electrolyte, which may reduce ion conductivity.

The present invention has been made in view of the above circumstances, and aims to provide an all-solid-state battery with high ion conductivity in the solid electrolyte layer and a method of manufacturing such an all-solid-state battery.

The inventors of the present invention have found that the above problems can be solved by forming a solid electrolyte layer, in which a second solid electrolyte layer is pressure-bonded to one surface of a first solid electrolyte layer containing a first solid electrolyte composition filled in the pores of a porous base material, and the second solid electrolyte layer contains a second solid electrolyte composition and does not contain a base material, thereby arriving at completion of the present invention. Therefore, the present invention provides the following.

(1) An all-solid-state battery includes a pressure-bonded laminate in which a positive electrode layer, a negative electrode layer, and a solid electrolyte layer arranged between the positive electrode layer and the negative electrode layer are pressure-bonded together, in which the solid electrolyte layer includes a first solid electrolyte layer and a second solid electrolyte layer pressure-bonded to one surface of the first solid electrolyte layer, the first solid electrolyte layer is a base-material-containing body that includes a porous base material and a first solid electrolyte composition containing a solid electrolyte filled within pores of the porous base material, and the second solid electrolyte layer is a base-material-free body that includes a second solid electrolyte composition containing a solid electrolyte and does not include a base material.

According to the all-solid-state battery as described in (1), the pressure-bonded laminate includes the solid electrolyte layer, in which the first solid electrolyte layer and the second solid electrolyte layer are pressure-bonded; therefore, the pinholes formed in the first solid electrolyte layer are filled with the second solid electrolyte composition of the second solid electrolyte layer. Therefore, the all-solid-state battery including the pressure-bonded laminate exhibits enhanced ion conductivity of the solid electrolyte layer and improved high-rate characteristic.

(2) In the all-solid-state battery as described in (1), the first solid electrolyte layer is pressure-bonded to the positive electrode layer, and the second solid electrolyte layer is pressure-bonded to the negative electrode layer.

According to the all-solid-state battery as described in (2), the first solid electrolyte layer containing the porous base material is pressure-bonded to the positive electrode layer, whereby high-strength materials can be used for the positive electrode layer. The second solid electrolyte layer, which does not contain a porous base material, is pressure-bonded to the negative electrode layer, whereby the low-strength materials can be used for the negative electrode layer.

(3) In the all-solid-state battery as described in (1) or (2), an outer peripheral edge of the first solid electrolyte layer is larger, in a plan view, than an outer peripheral edge of at least one among the positive electrode layer and the negative electrode layer.

According to the all-solid-state battery as described in (3), the outer peripheral edge of the first solid electrolyte layer is larger, in a plan view, than the outer peripheral edges of at least one among the positive electrode layer and the negative electrode layer, thereby reducing the likelihood of short-circuiting between the positive electrode layer and the negative electrode layer.

(4) In the all-solid-state battery as described in any one of (1) to (3), the first solid electrolyte composition and the second solid electrolyte composition each contain a binder, and the binder content in the first solid electrolyte composition is higher than the binder content in the second solid electrolyte composition.

According to the all-solid-state battery as described in (4), the higher binder content in the first solid electrolyte composition enhances adhesiveness with the porous base material, and thus pinholes are unlikely to occur in the first solid electrolyte layer. The lower binder content in the second solid electrolyte composition improves the ion conductivity of the second solid electrolyte layer.

(5) In the all-solid-state battery as described in any one of (1) to (4), the positive electrode layer includes a sheet-shaped positive electrode current collector and two positive electrode active material layers stacked on both surfaces of the positive electrode current collector, and the negative electrode layer is arranged so as to sandwich the positive electrode layer.

According to the all-solid-state battery as described in (5), the solid electrolyte layer is arranged on the surfaces of the two positive electrode active material layers, resulting in a pouch-shaped structure surrounding the positive electrode layer with the solid electrolyte layer. This structure prevents the negative electrode tab connected to the negative electrode layer from encircling the positive electrode layer, whereby it is possible to suppress short-circuit between the positive electrode layer and the negative electrode layer.

(6) A method of manufacturing an all-solid-state battery, including pressure-bonding each layer by pressurizing a stack, in which a positive electrode layer, a negative electrode layer, and a solid electrolyte layer arranged between the positive electrode layer and the negative electrode layer are stacked, the solid electrolyte layer includes a first solid electrolyte layer and a second solid electrolyte layer arranged on one surface of the first solid electrolyte layer, the first solid electrolyte layer is a base-material-containing body that includes a porous base material and a first solid electrolyte composition containing a solid electrolyte filled within pores of the porous base material, and the second solid electrolyte layer is a base-material-free body that includes a second solid electrolyte composition containing a solid electrolyte and does not include a base material.

According to the method of manufacturing an all-solid-state battery as described in (6), the first solid electrolyte layer and the second solid electrolyte layer are pressure-bonded, whereby the pinholes formed in the first solid electrolyte layer can be filled with the second solid electrolyte composition of the second solid electrolyte layer. As a result, the obtained all-solid-state battery exhibits high ion conductivity of the solid electrolyte layer and improved high-rate characteristic.

(7) In the method of manufacturing an all-solid-state battery as described in (6), the first solid electrolyte layer of the stack is stacked on the positive electrode layer, and the second solid electrolyte layer is stacked on the negative electrode layer.

According to the method of manufacturing an all-solid-state battery as described in (7), the first solid electrolyte layer containing the porous base material is pressure-bonded to the positive electrode layer, whereby high-strength materials can be used for the positive electrode layer. The second solid electrolyte layer, which does not contain a porous base material, is pressure-bonded to the negative electrode layer, whereby the low-strength materials can be used for the negative electrode layer.

(8) In the method of manufacturing an all-solid-state battery as described in (7), the positive electrode layer and the first solid electrolyte layer of the stack are pressure-bonded.

According to the method of manufacturing an all-solid-state battery as described in (8), the positive electrode layer and the first solid electrolyte layer are pressure-bonded in advance, whereby the obtained all-solid-state battery has enhanced adhesiveness between the positive electrode layer and the first solid electrolyte layer and improved ion conductivity between the positive electrode layer and the solid electrolyte layer.

(9) In the method of manufacturing an all-solid-state battery as described in (7) or (8), the negative electrode layer and the second solid electrolyte layer of the stack are pressure-bonded.

According to the method of manufacturing an all-solid-state battery as described in (9), the negative electrode layer and the second solid electrolyte layer are pressure-bonded in advance, whereby the obtained all-solid-state battery has enhanced adhesiveness between the negative electrode layer and the second solid electrolyte layer and improved ion conductivity between the negative electrode layer and the solid electrolyte layer.

The present invention makes it possible to provide an all-solid-state battery with high ion conductivity in the solid electrolyte layer, and a method of manufacturing such an all-solid-state battery.

### BRIEF DESCRIPTION OF THE DRAWINGS

FIG. 1 is a plan view illustrating a pressure-bonded laminate of an all-solid-state battery according to one embodiment of the present invention;

FIG. 2 is a cross-sectional view along the line II-II of FIG. 1;

FIG. 3 is a cross-sectional view illustrating a method of manufacturing an all-solid-state battery according to one embodiment of the present invention, illustrating a cross-sectional view of a pressure-bonded laminate of positive electrode layer and first solid electrolyte layer;

FIG. 4 is a cross-sectional view illustrating a pressure-bonded laminate of negative electrode layer and second solid electrolyte layer obtained by the method of manufacturing an all-solid-state battery according to one embodiment of the present invention; and

FIG. 5 is a cross-sectional view illustrating a step of pressure-bonding a stack, which is one of the steps in the method of manufacturing an all-solid-state battery according to one embodiment of the present invention.

### DETAILED DESCRIPTION OF THE INVENTION

Hereinafter, embodiments of the present invention will be described with reference to the drawings. However, the embodiments described below are merely illustrative and do not limit the scope of the present invention.

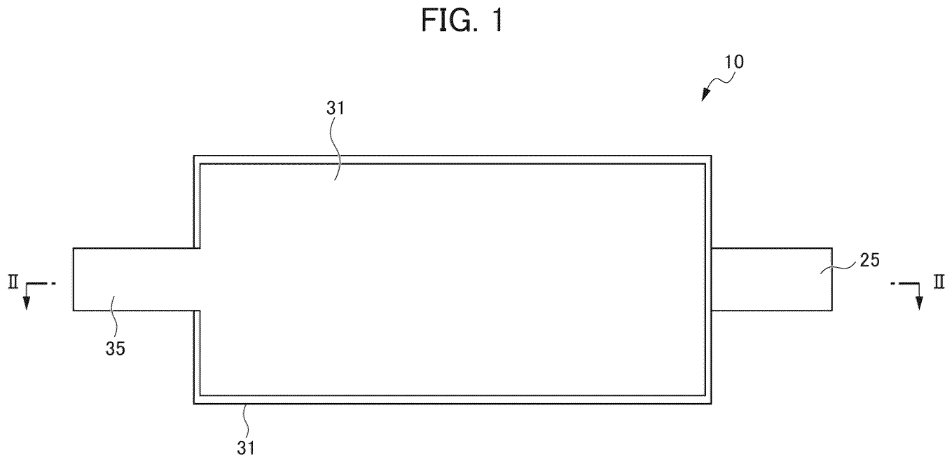

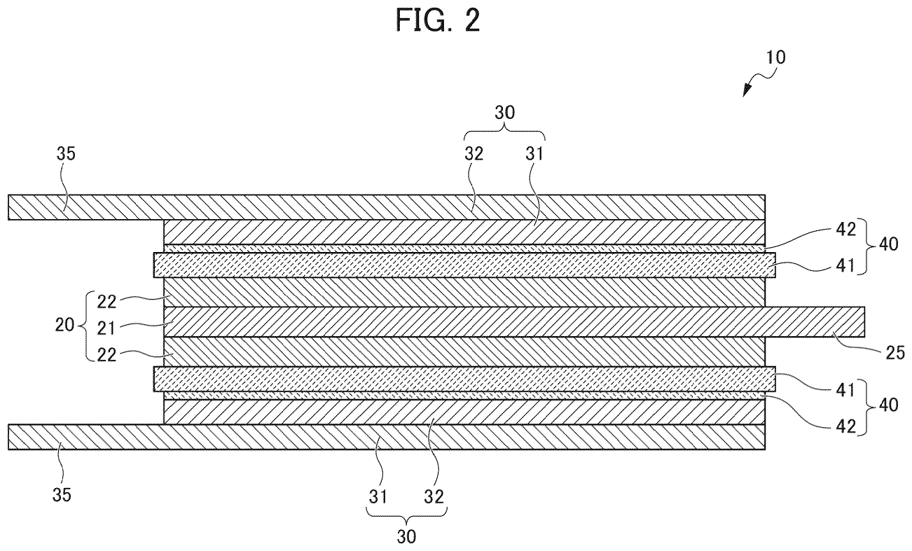

FIG. 1 is a plan view illustrating a pressure-bonded laminate of an all-solid-state battery according to one embodiment of the present invention. FIG. 2 is a cross-sectional view along the line II-II of FIG. 1. As illustrated in FIGS. 1 and 2, the pressure-bonded laminate 10 is a stack formed by pressure-bonding a positive electrode layer 20, a negative electrode layer 30, and solid electrolyte layers arranged between the positive electrode layer 20 and the negative electrode layer 30 together.

The positive electrode layer 20 includes a positive electrode current collector 21 and two positive electrode active material layers 22 stacked on both surfaces of the positive electrode current collector 21. The positive electrode current collector 21 is connected to a positive electrode tab 25. The negative electrode layers 30 are arranged to oppose the positive electrode layer 20 on both sides. Each of the two opposing negative electrode layers 30 includes a negative electrode current collector 31 and a metal layer 32 stacked on the surface of the negative electrode current collector 31 facing the solid electrolyte layer 40. The negative electrode current collector 31 is connected to a negative electrode tab 35. The solid electrolyte layer 40 is arranged between the positive electrode active material layer 22 and the negative electrode current collector 31. The solid electrolyte layer 40 includes a first solid electrolyte layer 41 and a second solid electrolyte layer 42 pressure-bonded to one surface of the first solid electrolyte layer 41. The first solid electrolyte layer 41 is pressure-bonded to the positive electrode layer 20, and the second solid electrolyte layer 42 is pressure-bonded to the negative electrode layer 30. The outer peripheral edge of the first solid electrolyte layer 41 is larger, in a plan view, than the outer peripheral edge of the positive electrode layer 20.

The first solid electrolyte layer 41 is a base-material-containing body including a porous base material and a first solid electrolyte composition filled in the pores of the porous base material. The second solid electrolyte layer 42 is a base-material-free body that includes a second solid electrolyte composition containing a solid electrolyte and does not include a base material. By pressure-bonding the first solid electrolyte layer 41 and the second solid electrolyte layer 42, and pressing the second solid electrolyte layer 42 against pinholes formed in the first solid electrolyte layer 41, the pinholes can be filled with the second solid electrolyte composition.

The positive electrode current collector 21 is not particularly limited in material or shape so long as having a function as a current collector for the positive electrode layer 20. Examples of materials for the positive electrode current collector 21 include aluminum, aluminum alloy, stainless steel, nickel, iron, and titanium, in which aluminum, aluminum alloy, and stainless steel are preferred. Examples of the shape of the positive electrode current collector 21 include foil and plate.

The positive electrode active material layer 22 contains at least one type of positive electrode active material. There is no particular limitation on the positive electrode active material, and common materials used for positive electrode layers in all-solid-state batteries can be employed. Examples of positive electrode active materials include layered active materials containing lithium, spinel-type active materials, and olivine-type active materials. Specific examples of positive electrode active materials include lithium cobalt oxide (LiCoO₂), lithium nickel oxide (LiNiO₂), LiNiₚMn_{q}COᵣO_{z} (where p+q+r=1), LiNiₚAl_{q}COᵣO₂ (where p+q+r=1), lithium manganese oxide (LiMn₂O₄), heteroelement-substituted Li—Mn spinel such as Li₁₊ₓMn_{2-x-y}MO₄ (where x+y=2, and M is at least one element selected from Al, Mg, Co, Fe, Ni, and Zn), lithium titanate (an oxide containing Li and Ti), and lithium metal phosphate (LiMPO₄, where M is at least one element selected from Fe, Mn, Co, and Ni).

The positive electrode active material layer 22 may optionally contain a solid electrolyte to improve lithium ion conductivity. A conductive additive may be optionally contained to improve electrical conductivity. A binder may be optionally contained to impart flexibility or other properties. The solid electrolyte, the conductive additive, and the binder are not particularly limited, and may be any materials commonly used in positive electrode layers of all-solid-state batteries.

The material for the positive electrode tab 25 may be the same as the material for the positive electrode current collector 21, or may be different from the material for the positive electrode current collector 21. The positive electrode tab 25 may be integrally connected to the positive electrode current collector 21. In the present embodiment, the positive electrode tab 25 is formed by extending the positive electrode current collector 21 and is integrally connected to the positive electrode current collector 21.

The negative electrode current collector 31 is not particularly limited in material or shape so long as having a function as a current collector for the negative electrode layer 30. Examples of materials for the negative electrode current collector 31 include nickel, copper, and stainless steel. Examples of the shape of the negative electrode current collector 31 include foil and plate.

The metal layer 32 is not particularly limited in material or shape so long as having a function of densely depositing lithium ions. The metal layer 32 may be a metallic lithium layer or a layer of a metal that forms an alloy with lithium. Examples of metals that form alloys with lithium include Mg, Si, Au, Ag, In, Ge, Sn, Pb, Al, and Zn. The metal forming the metal layer 32 may be in the form of powder or a thin film. By employing the negative electrode layer 30 including the metal layer 32, a uniform lithium deposition layer can be formed on the surface of the metal layer 32.

The material for the negative electrode tab 35 may be the same as the material for the negative electrode current collector 31, or may be different from the material for the negative electrode current collector 31. The negative electrode tab 35 may be integrally connected to the negative electrode current collector 31. In the present embodiment, the negative electrode tab 35 is formed by extending the negative electrode current collector 31 and is integrally connected to the negative electrode current collector 31.

The thickness of the first solid electrolyte layer 41 of the solid electrolyte layer 40 may be the same as or different from the thickness of the second solid electrolyte layer 42. For example, the thickness of the second solid electrolyte layer 42 may be greater than the thickness of the first solid electrolyte layer 41.

Examples of porous base materials included in the first solid electrolyte layer 41 include nonwoven fabrics and woven fabrics.

The first solid electrolyte composition of the first solid electrolyte layer 41 and the second solid electrolyte composition of the second solid electrolyte layer 42 may each contain a solid electrolyte and a binder. The solid electrolytes in the first solid electrolyte composition and the second solid electrolyte composition may be the same or different. The first solid electrolyte composition may contain two or more types of solid electrolytes with differing average particle sizes. For example, the composition may contain a fine solid electrolyte with an average particle size within the range of 0.1 μm to less than 0.5 μm and a coarse solid electrolyte with an average particle size within the range of 1.0 μm to 10.0 μm. The proportion of the fine solid electrolyte to the coarse solid electrolyte may be within the range of 1:9 to 9:1 by mass ratio. The fine solid electrolyte achieves the effect of improving the bondability between the first solid electrolyte layer 41 and the positive electrode layer 20. The coarse solid electrolyte achieves the effect of improving the filling property of the solid electrolyte composition within the first solid electrolyte layer 41. The average particle size of the solid electrolyte in the second solid electrolyte composition may be, for example, within the range of 1.0 μm to 10.0 μm. The average particle size of the solid electrolyte in the first solid electrolyte composition may be smaller than the average particle size of the solid electrolyte in the second solid electrolyte composition. The average particle size is a value measured by the laser diffraction scattering method.

The solid electrolyte in the first solid electrolyte composition and the second solid electrolyte composition are not particularly limited so long as having lithium ion conductivity; examples include sulfide solid electrolytes, oxide solid electrolytes, nitride solid electrolytes, and halide solid electrolytes.

Examples of sulfide solid electrolytes include Li₂S—P₂S₅ and Li₂S—P₂S₅—LiI. The sulfide solid electrolyte may have an argyrodite-type crystal structure.

Examples of oxide solid electrolytes include NASICON-type oxides, garnet-type oxides, and perovskite-type oxides. An example of a NASICON-type oxide is an oxide containing Li, Al, Ti, P, and O (e.g., Li_{1.5}Al_{0.5}Ti_{1.5}(PO₄)₃). An example of a garnet-type oxide is an oxide containing Li, La, Zr, and O (e.g., Li₇La₃Zr₂O₁₂). An example of a perovskite-type oxide is an oxide containing Li, La, Ti, and O (e.g., LiLaTiO₃).

The binders in the first solid electrolyte composition and the second solid electrolyte composition may be the same or different. The type of binder is not particularly limited, and may employ any binders commonly used for solid electrolyte layers in all-solid-state batteries. The binder content in the first solid electrolyte composition may be set from a standpoint of, for example, the adhesiveness between the first solid electrolyte composition and the porous base material, and the strength and ion conductance of the entire first solid electrolyte layer 41. The binder content in the second solid electrolyte composition may be set from a standpoint of, for example, the adhesiveness with the first solid electrolyte layer 41, and the ion conductance of the entire second solid electrolyte layer 42. The binder content in the first solid electrolyte composition may be higher than the binder content in the second solid electrolyte composition. The binder content in the first solid electrolyte composition may be, for example, within the range of 1.5 to 10 times the binder content in the second solid electrolyte composition.

The pressure-bonded laminate 10 is housed in a housing (not illustrated). The housing includes a positive electrode terminal connected to the positive electrode tab 25, and a negative electrode terminal connected to the negative electrode tab 35.

Examples of materials that can be used for the housing include a laminated film. The laminated film may be a three-layer laminated film composed of an inner resin layer, a metal layer, and an outer resin layer, stacked in this order from the inner side. The outer resin layer may be a polyamide (nylon) layer or a polyethylene terephthalate (PET) layer, the metal layer may be an aluminum layer, and the inner resin layer may be a polyethylene or polypropylene layer.

In the pressure-bonded laminate 10 of the present embodiment as configured above, the first solid electrolyte layer 41 and the second solid electrolyte layer 42 of the solid electrolyte layer 40 are pressure-bonded. As a result, the pinholes formed in the first solid electrolyte layer 41 are filled with the second solid electrolyte composition of the second solid electrolyte layer 42. This enhances the ion conductivity of the solid electrolyte layer 40, and improves the high-rate performance of the all-solid-state battery including the pressure-bonded laminate 10.

In the pressure-bonded laminate 10 of the present embodiment, the first solid electrolyte layer 41 is pressure-bonded to the positive electrode layer 20, whereby high-strength materials can be used for the positive electrode active material layer 22. Similarly, the second solid electrolyte layer 42 is pressure-bonded to the negative electrode layer 30, whereby low-strength materials can be used for the metal layer 32.

In the pressure-bonded laminate 10 of the present embodiment, the outer peripheral edge of the first solid electrolyte layer 41 is larger, in a plan view, than the outer peripheral edge of the positive electrode layer 20, thereby reducing the likelihood of short-circuiting between the positive electrode layer 20 and the negative electrode layer 30. The solid electrolyte layer 40 is arranged on the surfaces of the two positive electrode active material layers 22, resulting in a pouch-shaped structure surrounding the positive electrode layer 20 with the solid electrolyte layers 40. This structure prevents the negative electrode tab 35 from encircling the positive electrode layer 20, thereby reducing the likelihood of short-circuiting between the positive electrode layer 20 and the negative electrode layer 30.

In the pressure-bonded laminate 10 of the present embodiment, the first solid electrolyte composition has a high binder content, which enhances the adhesiveness to the porous base material, thereby reducing the likelihood of forming pinholes in the first solid electrolyte layer 41. The low binder content in the second solid electrolyte composition increases the ion conductivity of the second solid electrolyte layer 42.

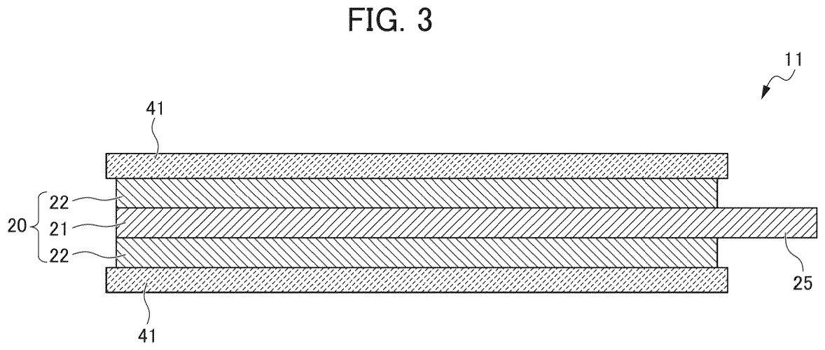

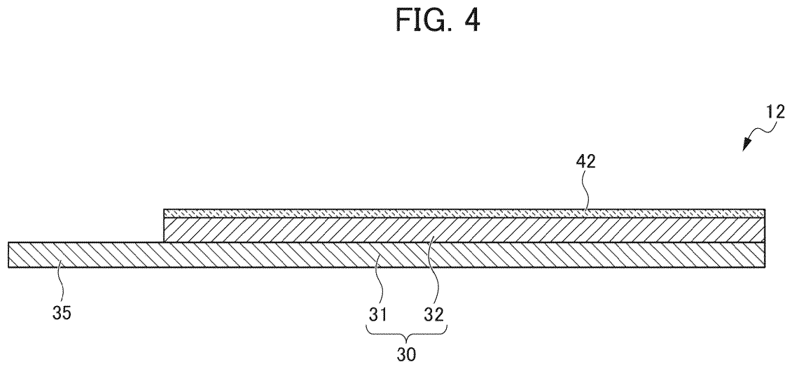

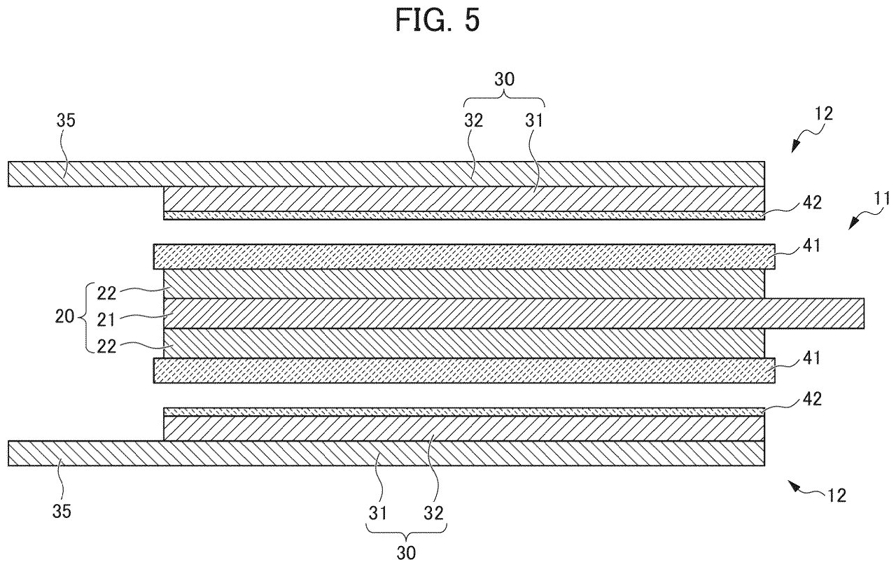

The method of manufacturing the pressure-bonded laminate 10 in the present embodiment is described below with reference to FIGS. 3 to 5. FIG. 3 is a cross-sectional view illustrating the method of manufacturing an all-solid-state battery according to one embodiment of the present invention, illustrating the cross-section of the pressure-bonded laminate of positive electrode layer and first solid electrolyte layer. FIG. 4 is a cross-sectional view illustrating the pressure-bonded laminate of negative electrode layer and second solid electrolyte layer obtained by the method of manufacturing an all-solid-state battery according to one embodiment of the present invention. FIG. 5 is a cross-sectional view illustrating the step of pressure-bonding the stack, which is one of the steps in the method of manufacturing an all-solid-state battery according to one embodiment of the present invention.

With the method of manufacturing the pressure-bonded laminate 10 of the present embodiment, first, as illustrated in FIG. 3, a pressure-bonded laminate of positive electrode layer and first solid electrolyte layer 11 is obtained by pressure-bonding the positive electrode layer 20 and the first solid electrolyte layer 41. The pressure-bonded laminate of positive electrode layer and first solid electrolyte layer 11 can be manufactured by stacking the positive electrode active material layer 22 of the positive electrode layer 20 and the first solid electrolyte layer 41, and pressurizing. A roll press may be used as the pressurizing device.

As illustrated in FIG. 4, a pressure-bonded laminate of negative electrode layer and second solid electrolyte layer 12 is obtained by pressure-bonding the metal layer 32 of the negative electrode layer 30 and the second solid electrolyte layer 42. The pressure-bonded laminate of negative electrode layer and second solid electrolyte layer 12 can be manufactured by stacking the metal layer 32 of the negative electrode layer 30 and the second solid electrolyte layer 42, and pressurizing. A roll press may be used as the pressurizing device. The pressing pressure may be lower than the pressure used in manufacturing the pressure-bonded laminate of positive electrode layer and first solid electrolyte layer 11.

Next, as illustrated in FIG. 5, the first solid electrolyte layer 41 of the pressure-bonded laminate of positive electrode layer and first solid electrolyte layer 11 is stacked with the second solid electrolyte layer 42 of the pressure-bonded laminate of negative electrode layer and second solid electrolyte layer 12, thereby obtaining a stack, in which the positive electrode layer 20, the negative electrode layer 30, and the first and second solid electrolyte layers 41, 42 arranged between the positive electrode layer 20 and the negative electrode layer 30 are stacked. Then, the stack is pressurized to pressure-bond the first solid electrolyte layer 41 and the second solid electrolyte layer 42. The pressing pressure may be lower than the pressure used in manufacturing the pressure-bonded laminate of positive electrode layer and first solid electrolyte layer 11. However, the pressing pressure may be higher than the pressure used in manufacturing the metal layer 32 and the second solid electrolyte layer 42.

The all-solid-state battery may be manufactured as follows. In the pressure-bonded laminate 10 thus obtained, the positive electrode tab 25 is connected to the positive electrode terminal, and the negative electrode tab 35 is connected to the negative electrode terminal. Next, the pressure-bonded laminate 10 is housed in the housing such that the ends of the positive electrode terminal and the negative electrode terminal protrude, and the housing is sealed.

According to the method of manufacturing the pressure-bonded laminate 10 as described above in the present embodiment, the first solid electrolyte layer 41 and the second solid electrolyte layer 42 are pressure-bonded, whereby the pinholes formed in the first solid electrolyte layer 41 can be filled with the second solid electrolyte composition of the second solid electrolyte layer 42. Consequently, the all-solid-state battery utilizing the resultant pressure-bonded laminate 10 exhibits high ion conductivity of the solid electrolyte layer 40 and improved high-rate characteristic.

With the method of manufacturing the pressure-bonded laminate 10 of the present embodiment, the first solid electrolyte layer 41 is pressure-bonded to the positive electrode layer 20, whereby high-strength materials can be used for the positive electrode active material layer 22. The second solid electrolyte layer 42 is pressure-bonded to the negative electrode layer 30, whereby low-strength materials can be used for the metal layer 32.

With the method of manufacturing the pressure-bonded laminate 10 of the present embodiment, the pressure-bonded laminate of positive electrode layer and first solid electrolyte layer 11 is used, in which the positive electrode layer 20 and the first solid electrolyte layer 41 are pressure-bonded in advance, whereby the pressure-bonded laminate 10 exhibits enhanced adhesiveness between the positive electrode layer 20 and the first solid electrolyte layer 41, and improved ion conductivity between the positive electrode layer 20 and the solid electrolyte layer 40. Similarly, the pressure-bonded laminate of negative electrode layer and second solid electrolyte layer 12 is used, in which the negative electrode layer 30 and the second solid electrolyte layer 42 are pressure-bonded in advance, whereby the pressure-bonded laminate 10 exhibits enhanced adhesiveness between the negative electrode layer 30 and the second solid electrolyte layer 42, and improved ion conductivity between the negative electrode layer 30 and the solid electrolyte layer 40.

Although an embodiment of the present invention has been described, the present invention is not limited to the above embodiment. For example, in the present embodiment, the positive electrode layer 20 includes the positive electrode active material layers 22 stacked on both sides of the positive electrode current collector 21; however, the positive electrode active material layer 22 may be stacked on only one side of the positive electrode current collector 21.

In the present embodiment, the first solid electrolyte layer 41 is pressure-bonded to the positive electrode layer 20, and the second solid electrolyte layer 42 is pressure-bonded to the negative electrode layer 30. However, the second solid electrolyte layer 42 may be pressure-bonded to the positive electrode layer 20, and the first solid electrolyte layer 41 may be pressure-bonded to the negative electrode layer 30.

In the present embodiment, the negative electrode layer 30 includes the metal layer 32; however, the metal layer 32 may be omitted, and lithium may be deposited directly onto the surface of the negative electrode current collector 31. Alternatively, instead of the metal layer 32, a layer containing a negative electrode active material capable of occluding and releasing lithium ions may be used. Examples of negative electrode active materials include lithium-transition metal oxides such as lithium titanate, transition metal oxides such as TiO₂, Nb₂O₃, and WOₙ, Si, SiO, metal sulfides, metal nitrides, as well as carbon materials such as artificial graphite, natural graphite, soft carbon, and hard carbon. The negative electrode active material layer may optionally contain a solid electrolyte to enhance lithium ion conductivity. A conductive additive may be contained to improve electrical conductivity. A binder may be optionally contained to impart flexibility or other properties. Solid electrolytes, conductive additives, and binders commonly used in solid secondary batteries may be employed.

With the method of manufacturing the pressure-bonded laminate 10 of the present embodiment, the first solid electrolyte layer 41 of the pressure-bonded laminate of positive electrode layer and first solid electrolyte layer 11 is pressure-bonded to the second solid electrolyte layer 42 of the pressure-bonded laminate of negative electrode layer and second solid electrolyte layer 12; however, this is not limiting. For example, a stack formed by stacking the positive electrode layer 20, the first solid electrolyte layer 41, the second solid electrolyte layer 42, and the negative electrode layer 30 may be pressurized to pressure-bond each layer. Alternatively, the solid electrolyte layer 40, which is obtained by pressure-bonding the first solid electrolyte layer 41 and the second solid electrolyte layer 42, may be arranged between the positive electrode layer 20 and the negative electrode layer 30, and the layers may be pressurized to pressure-bond each layer.

### EXPLANATION OF REFERENCE NUMERALS

10: pressure-bonded laminate
11: pressure-bonded laminate of positive electrode layer and first solid electrolyte layer
12: pressure-bonded laminate of negative electrode layer and second solid electrolyte layer
20: positive electrode layer
21: positive electrode current collector
22: positive electrode active material layer
25: positive electrode tab
30: negative electrode layer
31: negative electrode current collector
32: metal layer
35: negative electrode tab
40: solid electrolyte layer
41: first solid electrolyte layer
42: second solid electrolyte layer

What is claimed is:

1. An all-solid-state battery, comprising:
a pressure-bonded laminate in which a positive electrode layer, a negative electrode layer, and a solid electrolyte layer arranged between the positive electrode layer and the negative electrode layer are pressure bonded, wherein
the solid electrolyte layer includes a first solid electrolyte layer, and a second solid electrolyte layer pressure-bonded to one surface of the first solid electrolyte layer,
the first solid electrolyte layer is a base-material-containing body including a porous base material, and a first solid electrolyte composition containing a solid electrolyte filled within pores of the porous base material, and
the second solid electrolyte layer is a base-material-free body, including a second solid electrolyte composition containing a solid electrolyte, and does not include a base material.

2. The all-solid-state battery according to claim 1, wherein the first solid electrolyte layer is pressure-bonded to the positive electrode layer, and the second solid electrolyte layer is pressure-bonded to the negative electrode layer.

3. The all-solid-state battery according to claim 1, wherein an outer peripheral edge of the first solid electrolyte layer is larger, in a plan view, than an outer peripheral edge of at least one among the positive electrode layer and the negative electrode layer.

4. The all-solid-state battery according to claim 1, wherein the first solid electrolyte composition and the second solid electrolyte composition each contain a binder, and binder content in the first solid electrolyte composition is higher than binder content in the second solid electrolyte composition.

5. The all-solid-state battery according to claim 1, wherein the positive electrode layer includes a sheet-shaped positive electrode current collector and two positive electrode active material layers stacked on both surfaces of the positive electrode current collector, and the negative electrode layer is arranged so as to sandwich the positive electrode layer.

6. A method of manufacturing an all-solid-state battery, the method comprising pressure-bonding each layer by pressurizing a stack, wherein a positive electrode layer, a negative electrode layer, and a solid electrolyte layer arranged between the positive electrode layer and the negative electrode layer are stacked, the solid electrolyte layer includes a first solid electrolyte layer and a second solid electrolyte layer arranged on one surface of the first solid electrolyte layer, the first solid electrolyte layer is a base-material-containing body that includes a porous base material and a first solid electrolyte composition containing a solid electrolyte filled within pores of the porous base material, and the second solid electrolyte layer is a base-material-free body that includes a second solid electrolyte composition containing a solid electrolyte and does not include a base material.

7. The method of manufacturing an all-solid-state battery according to claim 6, wherein the first solid electrolyte layer of the stack is stacked on the positive electrode layer, and the second solid electrolyte layer is stacked on the negative electrode layer.

8. The method of manufacturing an all-solid-state battery according to claim 7, wherein the positive electrode layer and the first solid electrolyte layer of the stack are pressure-bonded.

9. The method of manufacturing an all-solid-state battery according to claim 7, wherein the negative electrode layer and the second solid electrolyte layer of the stack are pressure-bonded.
